(19) United States
(12) Patent Application Publication
(10) Pub. No.: US 2007/0058200 A1
(43) Pub. Date: Mar. 15, 2007

(54) System and method for generating multi-bit halftones using horizontal buildup

(75) Inventor: Ronald Pellar, Orange, CA (US)

Correspondence Address: TUCKER, ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/336,480

(22) Filed: Jan. 20, 2006

Related U.S. Application Data
(63) Continuation-in-part of application No. 11/224,419, filed on Sep. 12, 2005.

(51) Int. Cl. H04N 1/405

(52) U.S. Cl. 358/3.06; 358/3.13

(57) ABSTRACT

A multi-bit halftone generating system provides for halftone intergeneration in printers which can print dots of plural gray scale levels. Input image data includes information for more gray scale levels than can be handled by those associated with a printing device. Higher order bits of the pixels of the electronic document are used to select a gray scale level from those available from the printer. Remaining bits are used to generate a halftone pattern which is superimposed upon this selected gray scale. Thus, improved dither rendering is quickly and efficiently accomplished and improved image generation results from using the gray scales available from the printing device. A linearization lookup table allows for flexible compensation for any non-linearity in an output of an associated rendering device.

The subject application is a continuation-in-part of co-pending U.S. patent application Ser. No. 11/224,419 entitled SYSTEM AND METHOD FOR GENERATING LOW VISIBILITY MULTI-BIT HALFTONE, filed on Sep. 12, 2005, the content of which is incorporated herein by reference.

### BACKGROUND OF THE INVENTION

The subject invention relates generally to document rendering, and more particularly to rendering of gray scale images with devices that have a limited ability to print elements or data with a finite number of gray scale levels. The invention is particularly applicable to image rendering from printing devices. However, it will be appreciated that the teachings herein are suitably used in connection with any image rendering device, and in color renderings as well as in grayscale renderings.

Halftoning is a process by which gray scale images may be generated on a device that may, for example, only produce black dots on a white background. In a halftoning system, a small area or array of dots is treated as a large picture element (“halftone cell”). While this area is substantially larger than that of a dot, selectively turning on various dots or patterns of dots in this area allows it to be perceived, from a distance, as having a shade of gray associated with such a dot arrangement. These “dithered” areas are constructed so as to be placed to allow for visual perception of gray levels to be associated with each such area. Thus, halftoning allows for a trade off between resolution and gray scale. This allows for generation of fairly accurate, black-and-white images from a monotone document rendering device, such as a common laser printer.

More recently, devices such as printers have the ability to generate dots in two or more gray scale levels. While this additional capability allows for generation of high resolution gray scale levels, frequently the number of gray scale levels that are available for generation of a suitable image is insufficient for visual acceptability. Thus, a hybridized system that allows for generation of dithered or halftone images, which system also uses the gray scale capabilities native to a device, is advantageous.

Earlier systems that seek to use a combination of native gray scale levels with halftoning have been heretofore implemented with complicated procedures. Such procedures, for example, may incorporate a mechanism for switching between various arrays, each of which requires a specialized data structure. Additionally, such structures often require unique software or hardware environments to allow for generation of images.

It is desirable to have a system and method that quickly and simply implements halftoning in systems that have limited, native gray scale generation capability and that allows for ready implementation of standardized data structures for output in a multi-bit halftone image rendering device. It is further desirable to maximize usage of a full array of options of foreground and background color or grayscale levels in formation of dithered images to provide the best resolution possible given mechanical constraints of a document rendering device and input image.

### SUMMARY OF THE INVENTION

In accordance with the present invention, there is provided a system and method that quickly and simply implements halftoning in systems that have limited, native gray scale generation capability.

Further, in accordance with the present invention, there is provided a system and method that allows for ready implementation of standardized data structures for output in a multi-bit halftone image rendering device.

In accordance with the present invention, there is provided multi-bit halftone generator. The multi-bit halftone generator comprises means adapted for receiving n-bit binary encoded image data, the encoded image data including data representative of a plurality of pixels having one of 2ⁿ input palette values, wherein n is an integer greater than 1. The multi-bit halftone generator also includes means adapted for communicating data to an associated document processing device for rendering a document having 2^{m} output palette values, wherein m is a positive integer less than n. The multi-bit halftone generator further comprises means adapted for receiving data representative of at least one threshold array having at least 2^{n-m} elements and means adapted for selecting a background palette level from one of the 2^{m} output palette values in accordance with m high order bits of each received pixel. The multi-bit halftone generator further includes means adapted for selecting a foreground palette level from one of the 2^{m} output palette values and dither means adapted for selectively populating an array for each pixel in accordance with the at least one threshold array so as to form a two-dimensional dither matrix for each pixel comprised of elements having one of the background palette level and the foreground palette level.

Still further, in accordance with present invention, there is provided a method of generating a multi-bit halftone. The method comprises receiving n-bit binary encoded image data, the encoded image data including data representative of a plurality of pixels having 2ⁿ input palette values, wherein n is an integer greater than 1. The method also includes the step of communicating data to an associated document processing device having 2^{m} output palette values, wherein m is a positive integer less than n. The method further includes the steps of receiving data representative of at least one threshold array having at least 2^{n-m} elements and selecting a background palette level from one of the 2^{m} palette values in accordance with m high order bits of each received pixel. The method also comprises the steps of selecting a foreground palette level from one of the 2^{m} palette values and populating array elements for each pixel in accordance with the at least one threshold array so as to form a two-dimensional dither matrix for each pixel comprised of elements having one of the background palette level and the foreground palette level.

In accordance with a limited aspect of the present invention, dithering added to a dither matrix is accomplished to further define perceived gray scale for such matrix.

In accordance with a more limited aspect of the present invention, each dither matrix is provided with two gray scale levels, a first being defined as a selected background gray scale level and a second being associated with all elements that are used to selectively populate the dither matrix to accomplish half-toning.

An advantage of the present invention is the provision of a system that quickly and simply implements halftoning in systems that have limited, native gray scale generation capability.

Another advantage is the provision of a system which allows for ready implementation of standardized data structures for output in a multi-bit halftone image rendering device.

Yet another advantage is the provision of an image rendering system which allows for ready utilization of available, native gray scale levels as described in any common printer display language to produce multi-level halftones.

Yet another advantage is the reduced contrast between a dot and its surrounding dots for reduced visibility of the halftone pattern itself when compared to more conventional halftoning techniques.

Still other objects and aspects of the present invention will become readily apparent to those skilled in this art from the following description wherein there is shown and described a preferred embodiment of this invention, simply by way of illustration of one of the best modes suited for to carry out the invention. As it will be realized, the invention is capable of other different embodiments and its several details are capable of modifications in various obvious aspects all without from the invention. Accordingly, the drawing and descriptions will be regarded as illustrative in nature and not as restrictive.

### BRIEF DESCRIPTION OF THE DRAWINGS

The subject invention will be described in connection with a series of figures, which are used to disclose the preferred embodiment of the invention, and not for the purposes of limiting the same, wherein:

FIG. 1 is a block diagram of an image rendering system using the multi-bit halftone generator of the subject invention;

FIG. 2 illustrates a graph of horizontal buildup of a halftone in connection with the subject invention;

FIG. 3 illustrates a multi-bit halftone generator of the subject invention; and

FIG. 4 illustrates a representative example of a multi-bit halftone generation in connection with the subject invention.

### DETAILED DESCRIPTION OF THE PREFERRED EMBODIMENT

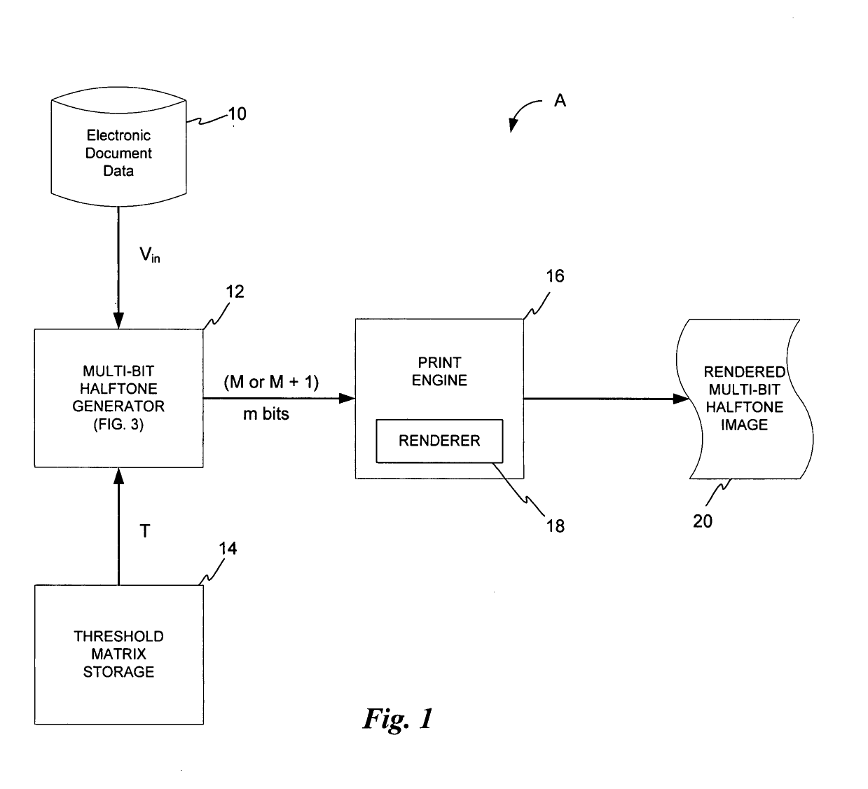

Turning to FIG. 1, an image rendering system 100 includes a multi-bit halftone generator 12 that receives electronic document data suitably in any standardized format via any suitable means. In a preferred embodiment, a PostScript format as propagated by Adobe Systems, Inc., is received as a threshold array T, such as that employed in Adobe Systems Type 1, Type 3, Type 6 or Type 10 formats. However, it is to be appreciated by one of ordinary skill in the art that any suitable page description language is contemplated for use.

In FIG. 1, electronic document data 10 is input as Vᵢₙ to a multi-bit halftone generator 12. The document data 10 is of any electronic document for which output is desired. It will be appreciated that such documents are suitably bit-mapped, vector-based or character-based, or any combination thereof, as will be appreciated by one of ordinary skill in the art. The multi-bit halftone generator 12 is connected via any suitable means to receive threshold matrix information from threshold matrix storage 14. The threshold matrix is used to generate halftone patterns as will be described in more detail below. While the preferred embodiment is directed to gray scale halftone generator, it is to be appreciated that the subject system is fully capable to generate color tones in systems in which only a limited color palette is available. A multi-bit halftone image that has been generated by the generator 12 is communicated to a print engine 16. The print engine 16 includes an image rendering function or renderer 18 that generates a bitmapped image from electronic document data, and functions to generate or render an image or graphic output 20 therefrom, which is suitable textual, pictorial, or a combination thereof.

In the illustration of FIG. 1, threshold matrix storage 14 communicates threshold matrix values T to the multi-bit halftone generator 12. In the preferred embodiment, each threshold matrix is an array corresponding to a build pattern of sub-pixels associated with pixels for a plurality of output pixels that ultimately form an image rendering. For example, a 5×5 threshold array suitably specifies an ordered build pattern by assigning a unique value to each of the 25 elements of the array. A build pattern suitably fills a lowest number value element of the array, and proceeds toward a highest value element until the result is that the entire corresponding pixel has been filled. However, it is to be appreciated that any progressive build pattern scheme is suitable, and contemplated herein. Particular choices for background and foreground colors or grayscale levels associated with such a pixel build are detailed below.

A capability of a rendering component of a document processing device to generate tonal values corresponding to more than one bit is suitably implemented in a way where threshold values of an array are used completely between two output levels. This is an improvement to more usual implementations of multi-bit halftone schemes which do not fully use available halftone patterns or combinations. If an image value is less than the threshold value, then the lower of two output values is chosen. If the image value is greater than or equal to the threshold value, then the higher of the two output values is generated.

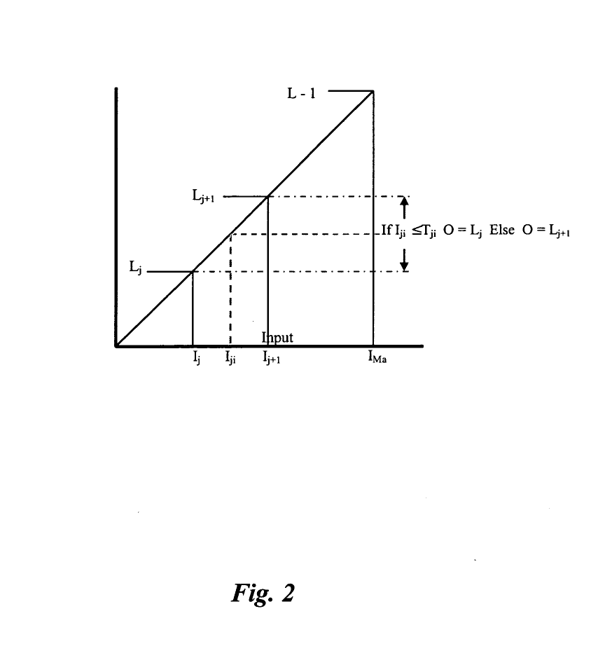

Turning now to FIG. 2, there is illustrated simple example for a subtractive color space. Illustrated graphically is a relationship between input values I along the abscissa and a number of values L that a halftone is able to output is illustrated along the ordinate. Any suitable color space is applicable. Such color spaces include, but are not limited to: cyan, magenta, and yellow (“CMY”); cyan, magenta, yellow, and black (“CMYK”) or red, yellow, and blue (“RYB”). However, it is to be appreciated that the subject system is not limited to subtractive color spaces, but to any suitable color space, including additive color spaces such as red, green, and blue (“RGB”), and the like.

In FIG. 2, the number of possible halftone output values L is suitably greater than or equal to the number of values, M (=2^{m}−1), wherein m is a number of output bits corresponding to a particular output device that the document processing device, and more particularly a rendering component thereof is capable of outputting. Use of a value L greater than M, provides flexibility to compensate for any non-linearity in the renderer's output, that is linearity compensation, is suitably implemented with a small lookup table.

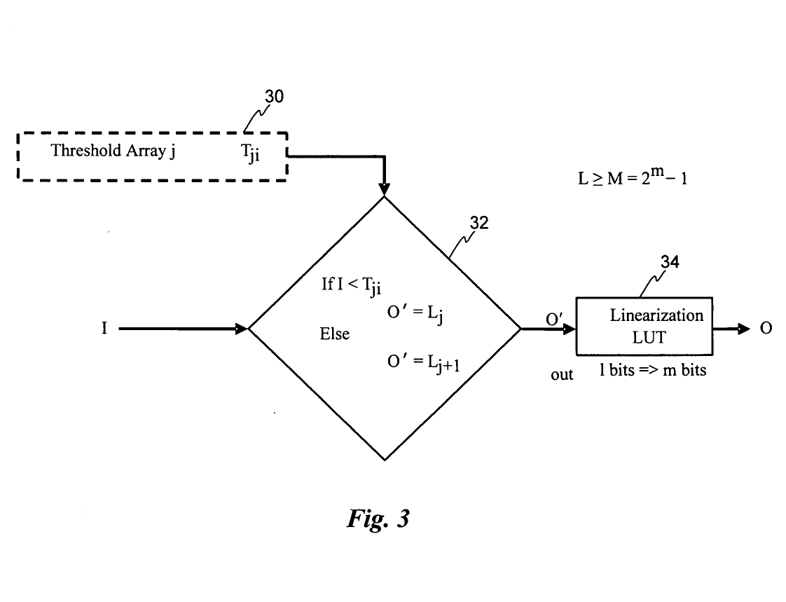

A general block diagram of a suitable linearization lookup table is shown in FIG. 3. In the illustration, a threshold matrix T is formed as a rectangular matrix populated by elements Tⱼᵢ, wherein j is an integer value representing each element's row position in the matrix and i is an integer representing its column position. Each threshold matrix element Tⱼᵢ 30 is communicated to a test block 32 for comparison to a corresponding input value I. If, as a result of such comparison, the threshold array element is determined to be greater that I, then a modified output value O′ is assigned a value of a corresponding halftone value Lⱼ. If not, a modified output value O′ is assigned a value of a corresponding halftone value Lⱼ₊₁. The value O′ is then communicated to linearization lookup table 34, where an corresponding table entry corresponding to an input O′ is retrieved, and output as result O. In FIG. 3 linearization lookup table 30 includes input values of 0 to L and corresponding output values ranging from 0 to M (the maximum number of renderer tonal values), wherein L≧M. An actual number of levels contained within a threshold array is independent of the number of levels that the renderer is able generate. Since each output tonal value is completely filled before the start of a next tonal value, the number of threshold values and the array design is advantageously independent and unique between any two output tonal values.

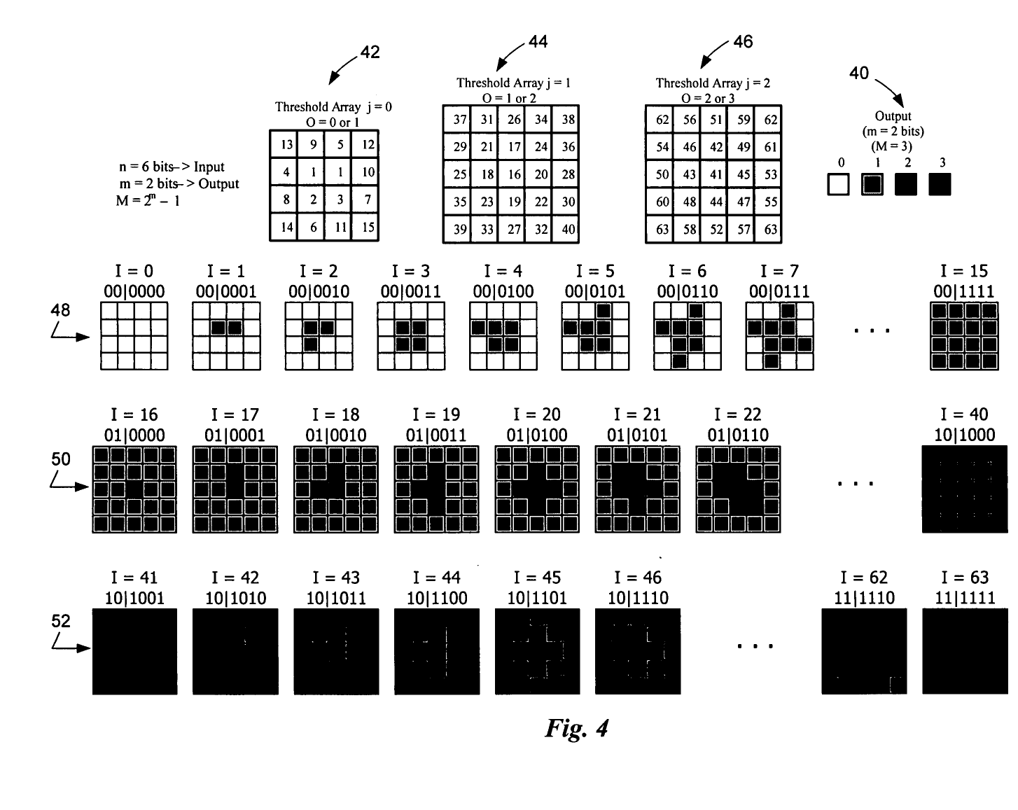

Turning to FIG. 4, illustrated is an example of a system constructed in accordance with the forgoing description. In the illustrate example, a threshold array T is formed as a rectangular (square in the example), matrix of up to 25 elements. An associated output device is capable of generation four grayscale levels, including a zero or no output level. The three grayscale levels are represented by two bits as shown at 40, such that m=2. Thus, the four possible output values for M are represented as mm having a value of 00, 10, 10 or 11. Also, in the illustrated example, input values I are formed from six bits n, allowing for 64 possible input grayscale values (000000, 000001, . . . , 111111), which represents zero through 63.

In the illustrated example of FIG. 4, if a number of output tonal values desired is 64 and the renderer can generate 4 levels (2 bits), then three threshold arrays are suitably used having 16 levels in the highlights, 25 levels in mid tones, and 25 levels in the shadows as shown. The illustrated threshold values have been assigned based upon a maximum image value of 63. It should be noted that between the level I=0 and the level I=15 the array is only 4×4, as illustrated by array 42, having 16 elements. Threshold arrays 44 and 46, show as between I=16 and I=63, are 5×5 arrays having 25 elements. A total number of array values is 66 with several levels, that is, I=1, I=62, and I=63, repeated.

Turning to row 48 of FIG. 4, illustrated is a build pattern for a first input level pf a highlight region employing a 16 element threshold array. The leftmost, or most significant, two bits of input bits n re illustrated separately insofar as these bits are advantageously used to determine a build pattern for pixels formulated for the multi-bit halftone output corresponding to a first level of the bits m of the four output levels associated with the output device. As values for I increase, a build pattern follows that of the threshold array 42.

In a corresponding fashion, build patterns for arrays of rows 50 and 52 are made corresponding to the threshold arrays 40 and 46, respectively. Thus, in summary, the FIG. 4 illustrates an example of output utilizing these array, where the input image values I are represented by 6 bits (64 levels) and 1=m=2 bits (L=M=4) of renderer capability.

The independence of the threshold arrays between two output levels provides a great degree of flexibility in the design of the halftone. In the highlights a threshold array that is smaller and of higher frequency can be used to render graphical elements, like fine lines or kanji text, with light tonal values more consistently and with better readability. In the midtones a lower frequency halftone array can be used for more tonal gradations. In the shadow areas, similar trade-offs can be made to improve the rendering quality.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

While in the preferred embodiment the present invention is implemented in software, as those skilled in the art can readily appreciate it may also be implemented in hardware or a combination of software and hardware. Although the preferred embodiment has been described in detail, it should be understood that various changes, substitutions, and alterations can be made therein without departing from the spirit and scope of the invention as defined by the appended claims. It will be appreciated that various changes in the details, materials and arrangements of parts, which have been herein described and illustrated in order to explain the nature of the invention, may be made by those skilled in the area within the principle and scope of the invention as will be expressed in the appended claims.

What is claimed:

1. A multi-bit halftone generator comprising:
means adapted for receiving n-bit binary encoded image data, the encoded image data including data representative of a plurality of pixels having one of 2ⁿ input palette values, wherein n is an integer greater than 1;
means adapted for communicating data to an associated document processing device for rendering a document having 2^{m} output palette values, wherein m is an positive integer less than n;
means adapted for receiving data representative of at least one threshold array having at least 2^{n-m} elements;
means adapted for selecting a background palette level from one of the 2^{m} output palette values in accordance with m high order bits of each received pixel;
means adapted for selecting a foreground palette level from one of the 2^{m} output palette values; and
dither means adapted for selectively populating an array for each pixel in accordance with the at least one threshold array so as to form a two-dimensional dither matrix for each pixel comprised of elements having one of the background palette level and the foreground palette level.

2. The multi-bit halftone generator of claim 1 wherein each output palette value represents a grayscale level, and wherein a difference between the foreground palette level and the background palette level does not exceed one grayscale level.

3. The multi-bit halftone generator of claim 1 further comprising a plurality of unique threshold arrays, wherein each threshold array is applied to a selected, complementary subset of the 2ⁿ input palette values.

4. The multi-bit halftone generator of claim 3 further comprising three unique threshold arrays applied respectively to subsets comprising a highlight region, a mid tone region and a shadow region associated with received pixels.

5. The multi-bit halftone generator of claim 3 wherein each palette level represents a grayscale level.

6. The multi-bit halftone generator of claim 3 wherein each palette level represents a color value for a component of a selected color space.

7. A method of generating a multi-bit halftone comprising the steps of:
receiving n-bit binary encoded image data, the encoded image data including data representative of a plurality of pixels having 2ⁿ input palette values, wherein n is an integer greater than 1;
communicating data to an associated document processing device having 2^{m} output palette values, wherein m is a positive integer less than n;
receiving data representative of at least one threshold array having at least 2^{n-m} elements;
selecting a background palette level from one of the 2^{m} palette values in accordance with m high order bits of each received pixel;
selecting a foreground palette level from one of the 2^{m} palette values; and
populating array elements for each pixel in accordance with the at least one threshold array so as to form a two-dimensional dither matrix for each pixel comprised of elements having one of the background palette level and the foreground palette level.

8. The method of generating a multi-bit halftone of claim 7 wherein each output palette level represents a grayscale level, and wherein a difference between the foreground palette level and the background palette level does not exceed one grayscale level.

9. The method of generating a multi-bit halftone of claim 7 wherein the step of populating array elements includes the step of applying for each pixel a selected threshold array from a plurality of complementary subsets of the 2ⁿ input palette values.

10. The method of generating a multi-bit halftone of claim 9 wherein the step of populating further includes the step of selectively applying three unique threshold arrays to subsets comprising a highlight region, a mid tone region and a shadow region.

11. The method of generating a multi-bit halftone of claim 9 wherein each palette level represents a grayscale level.

12. The method of generating a multi-bit halftone of claim 9 wherein each palette level represents a color value for a component of a selected color space.

13. A computer-implemented method of generating a multi-bit halftone comprising the steps of:
receiving n-bit binary encoded image data, the encoded image data including data representative of a plurality of pixels having 2ⁿ input palette values, wherein n is an integer greater than 1;
communicating data to an associated document processing device having 2^{m} output palette values, wherein m is a positive integer less than n;
receiving data representative of at least one threshold array having at least 2^{n-m} elements;
selecting a background palette level from one of the 2^{m} palette values in accordance with m high order bits of each received pixel;
selecting a foreground palette level from one of the 2^{m} palette values; and
populating array elements for each pixel in accordance with the at least one threshold array so as to form a two-dimensional dither matrix for each pixel comprised of elements having one of the background palette level and the foreground palette level.

14. The computer-implemented method of generating a multi-bit halftone of claim 13 wherein each output palette level represents a grayscale level, and wherein a difference between the foreground palette level and the background palette level does not exceed one grayscale level.

15. The computer-implemented method of generating a multi-bit halftone of claim 13 wherein the step of populating array elements includes the step of applying for each pixel a selected threshold array from a plurality of complementary subsets of the 2ⁿ input palette values.

16. The computer-implemented method of generating a multi-bit halftone of claim 15 wherein the step of populating further includes the step of selectively applying three unique threshold arrays to subsets comprising a highlight region, a mid tone region and a shadow region.

17. The computer-implemented method of generating a multi-bit halftone of claim 15 wherein each palette level represents a grayscale level.

18. The computer-implemented method of generating a multi-bit halftone of claim 15 wherein each palette level represents a color value for a component of a selected color space.
